(19) United States
(12) Patent Application Publication
(10) Pub. No.: US 2008/0159867 A1
(43) Pub. Date: Jul. 3, 2008

(54) Impeller assembly

(76) Inventor: Sheng-An Yang, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/003,258

(22) Filed: Dec. 21, 2007

(30) Foreign Application Priority Data
Jan. 2, 2007 (TW) 096100001
Jun. 8, 2007 (TW) 096120690
Nov. 13, 2007 (TW) 096142769

(51) Int. Cl. B64C 27/46

(52) U.S. Cl. 416/203

(57) ABSTRACT

This invention relates to an impeller assembly comprising at least one ring member and an impeller, in which the ring member has an inner peripheral edge and an outer peripheral edge oppositely facing to each other; the impeller includes a body and multiple blades, wherein each blade has a front edge and a rear edge, which respectively define an inlet side and an outlet side; the multiple blades are mounted around the outer peripheral edge of the body and multiple flow channels are formed between the blades, and the ring member is provided at the outlet side of the flow channels. According to this configuration, the impeller is made by assembly type method so that the difficulty in mold releasing and machining resulted from interference between components can be overcome; furthermore the manufacturing is further facilitated.

### BACKGROUND OF THE INVENTION

1. Field of the Invention

The present invention relates to an impeller assembly, particularly to an impeller by which pressure of the airflow introduced by it is increased so that heat dissipating efficiency can be raised.

2. Brief Description of the Prior Art

As shown in FIG. 11, the conventional impeller (5) comprises a hollow body (51) in which a shaft (52) is provided at its center. The peripheral edge of the hollow body (51) is coaxial with the shaft (52). Multiple blades (53) are mounted around the peripheral edge of the hollow body (51), and multiple flow channels (54) are formed between the blades (53). When the impeller (5) is driven to rotate, air will be sucked into the flow channels (54) from the leading edge of the blades (53) and is blown out toward the rear edge. However, the flow channels (54) of the axial flow impeller (5) are designed to be equal in width, the outlet side (540) becomes wider such that air blown out from the blades (53) becomes easy to flow back to the flow channels (54). In this case, turbulence is easily generated on air pressure and flow field.

Referring to the U.S. Pat. No. 6,318,964, an impeller assembly is formed by an upper impeller and a lower impeller. The lower impeller has multiple booster blades mounted at equal distribution around the outer peripheral edge of the body. However, the outlet side is not provided with ring member such that the flow field of the impeller assembly is more turbulent, and such that there is not space for mounting booster blades. Thus, higher air pressure cannot be attained due to deficiency of more booster blades.

In addition, referring to the U.S. Pat. No. 7,182,572, in which the outlet side of the flow channels is provided with booster blades so as to reduce the width of outlet side. However, the blades of the impeller are arranged radially, the outlet side of the flow channels is gradually enlarged toward the tail of the blades. Thus, the outlet side of the tail of the blades is wider such that the flowing of air blown out from the blades back to the flow channels is easily generated. This will result in lower air pressure and thus in turbulent flow field.

Moreover, accompanying with more and more speedier operation of electronic equipment, heat generated by the electronic equipment is becoming higher and higher. Therefore, it is becoming more and more important in industries to raise heat dissipating efficiency of electronic equipment.

### SUMMARY OF THE INVENTION

In view of the above defects with respect to the conventional axial flow impeller, the object of the present invention is to provide an impeller assembly which increases air pressure of the impeller by ring member so as to raise heat dissipating efficiency.

In order to achieve above object, this invention provides an impeller assembly comprising at least one ring member and an impeller, in which the ring member has an inner peripheral edge and an outer peripheral edge oppositely facing to each other; the impeller includes a body and multiple blades, wherein each blade has a front edge and a rear edge, which respectively define an inlet side and an outlet side; these blades are arranged around the outer peripheral edge of the body and flow channels are formed between adjacent blades. Furthermore, the rear edges of the blades are provided with breaches having the same sectional shape with the ring member, and the ring member is provided in the breaches of the rear edges of the blades. Alternatively, the upper end edge of the ring member at inner side is connected oppositely with the lower end edge of the impeller.

According to this configuration, the impeller is made by assembly type method so that the difficulty in mold releasing and machining resulted from interference between components can be overcome.

### BRIEF DESCRIPTION OF THE DRAWINGS

The present invention will be better understood by the detailed description of the following preferred embodiments with reference to the accompanying drawings, in which:

FIG. 1 is a perspective exploded view showing the first preferred embodiment of the impeller assembly of the present invention.

FIG. 2 is an assembled sectional view showing the first preferred embodiment of the impeller assembly of the present invention.

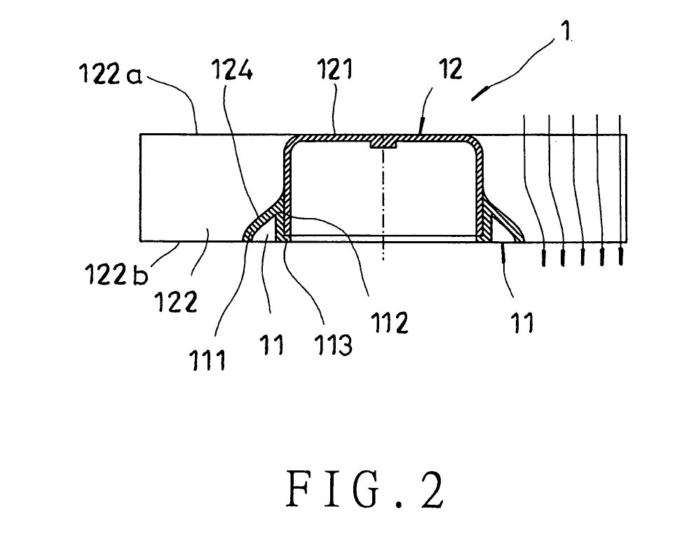

FIG. 3 is a perspective assembled view showing the second preferred embodiment of the impeller assembly of the present invention.

FIG. 4 is a perspective exploded view showing the third preferred embodiment of the impeller assembly of the present invention.

FIG. 5 is an assembled sectional view showing the third preferred embodiment of the impeller assembly of the present invention.

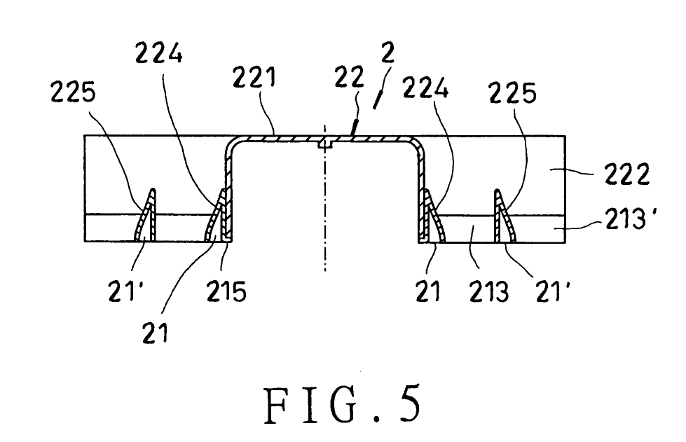

FIG. 6 is a perspective exploded view showing the fourth preferred embodiment of the impeller assembly of the present invention.

FIG. 7 is a perspective assembled view showing the fourth preferred embodiment of the impeller assembly of the present invention.

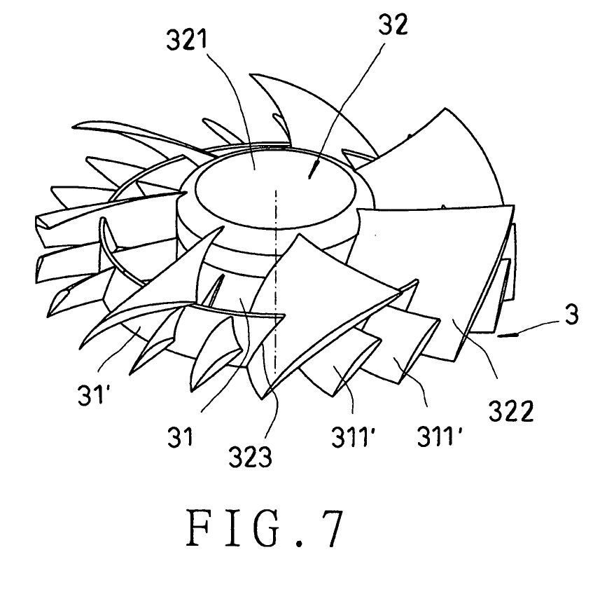

FIG. 8 is a perspective exploded view showing the fifth preferred embodiment of the impeller assembly of the present invention.

FIG. 9 is a perspective exploded view showing the sixth preferred embodiment of the impeller assembly of the present invention.

FIG. 10 is a perspective assembled view showing the sixth preferred embodiment of the impeller assembly of the present invention.

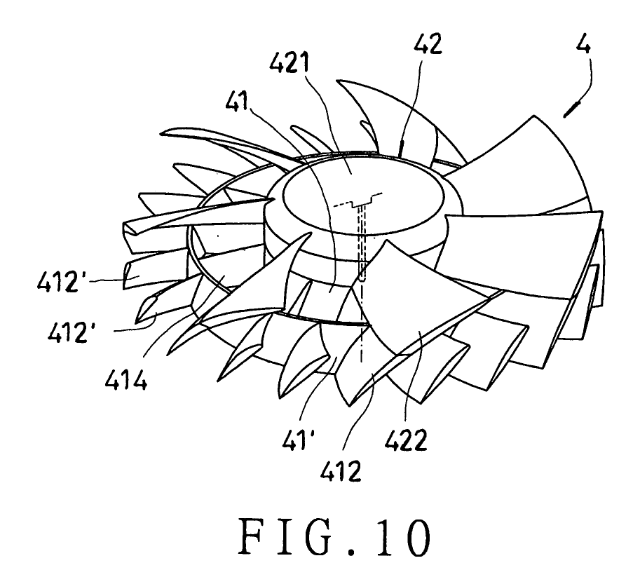

FIG. 11 is a perspective view showing a conventional impeller structure.

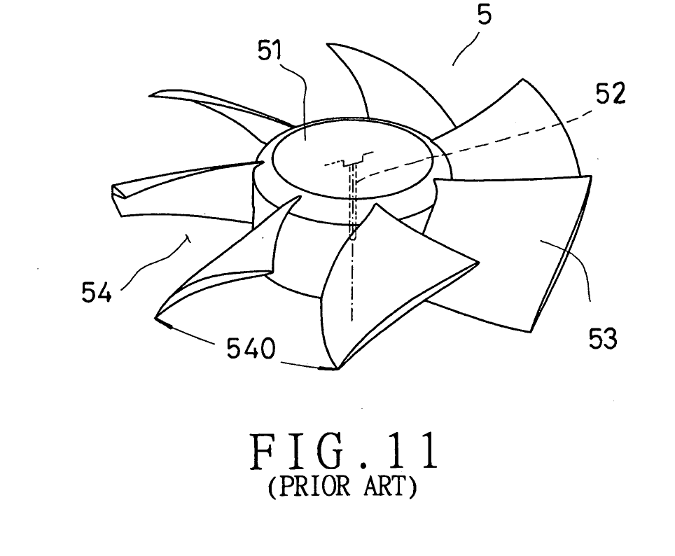

### DETAILED DESCRIPTION OF THE PREFERRED EMBODIMENTS

The objects, the technical contents and the expected effectiveness of the present invention will become more apparent from the detailed description of the preferred embodiments in conjunction with the accompanying drawings.

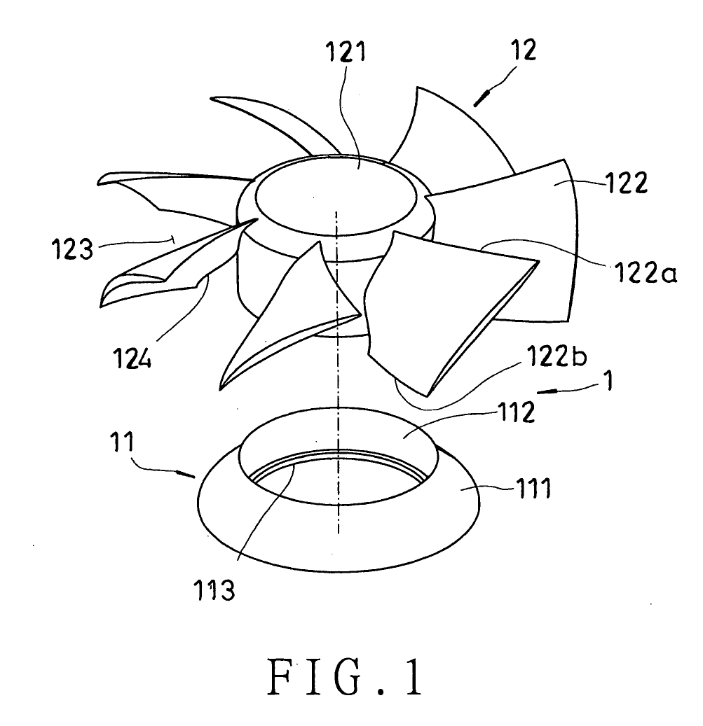

Firstly referring to FIG. 1, 2, the first preferred embodiment of the impeller assembly of the present invention is shown. The impeller assembly (1) comprises at least one ring member (11) and an impeller (12). In this embodiment, the impeller assembly (1) having one ring member (11) is taken as the example and is described as follow.

The ring member (11) is an annular structure, the sectional shape of which is narrow on upper side and wide on lower side. The outer peripheral edge (111) of the ring member (11) forms a slope shape or a streamline shape, and the inner peripheral edge (112) of the ring member (11) is provided with a protruding edge (113) at the outlet side.

The impeller (12) comprises a body (121) and multiple blades (122) which has a front edge (122a) and a rear edge (122b). The front edge (122a) and the rear edge (122b) respectively define the inlet side and the outlet side. The multiple blades (122) are arranged at equal distance along the peripheral edge of the body (121), and multiple flow channels (123) are formed between the blades (122). Furthermore, the rear edges (122b) of the blades (122) are provided with breaches (124) having the same sectional shape as the ring member (1).

In assembling, the ring member (11) is inserted into the breaches (124) of the blades (122) of the impeller (12) and is fixed in position by the engagement of the protruding edge (113) onto the bottom edge of the body (121).

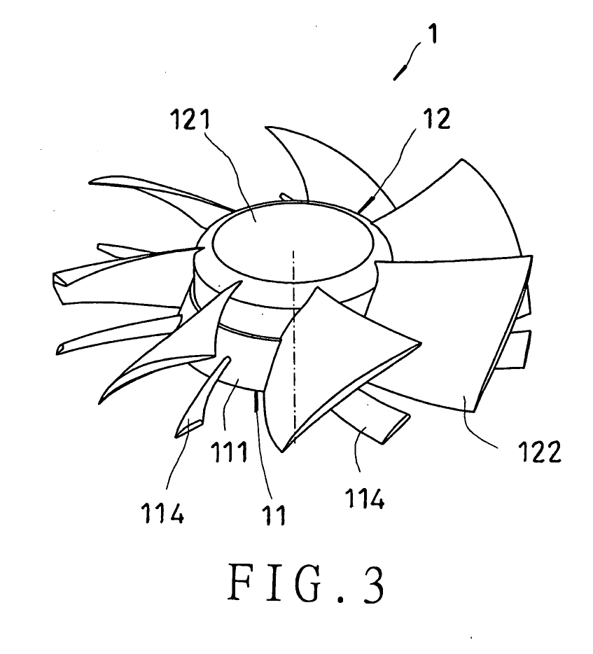

Referring to FIG. 3, the second preferred embodiment of the impeller assembly of the present invention is shown. The difference of this embodiment with the first embodiment will be described as below.

At least one boosting blade (114) is provided on the outer peripheral edge (111) of the single ring member (11), and the boosting blade (114) is just located within the flow channel (123) of the impeller (12) after the assembly of the ring member (11) and the impeller (12). Thus, the pressure of the blow-out air can be raised by the boosting blade (114).

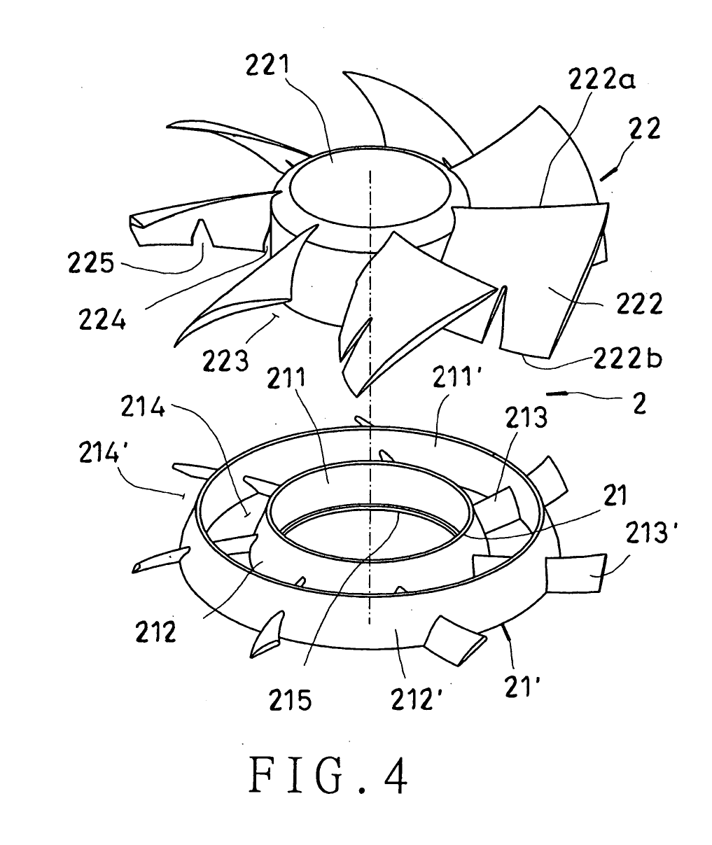

Referring to FIG. 4, 5, the third preferred embodiment of the impeller assembly of the present invention is shown. The impeller assembly (2) comprises at least two ring members (21, 21′) and an impeller (22). In this embodiment, the impeller assembly (2) having two ring members (21, 21′) is taken as the example and described as follow.

The two ring members (21, 21′) are respectively defined as an inner ring member (21) which is in proximity to the body (221) of the impeller (22), and an outer ring member (21′) which is far away from the body (221) of the impeller (22). The inner and the outer ring member (21, 21′) have respectively an inner peripheral edge (211, 211′) and an outer peripheral edge (212, 212′). The cross section of the inner and outer ring member (21, 21′) is narrow on upper side and wide on lower side, and the outer peripheral edges (212, 212′) of the inner and outer ring member (21, 21′) forms a slope shape or a streamline shape. At least one rib (213) is provided between the inner and outer ring member (21, 21′) for connecting the outer peripheral edge (212) of the inner ring member (21) and the inner peripheral edge (211′) of the outer ring member (21′). The cross section of the rib (213) can be rectangular, circular, triangular or air-foil shape. In this embodiment, the cross section of the rib (213) is preferably an air-foil shape such that the structure of the rib (213) looks like the boosting blade. Furthermore, at least one boosting blade (213′) is provided on the outer peripheral edge (212′) of the outer ring member (21′), meanwhile under the design with the inner and outer ring member (21, 21′), the flow channels (223) opposite to the impeller (22) are divided into two parts (214, 214′), and the outlet side at the inner peripheral edge (211) of the inner ring member (21) is provided with a protruding edge (215).

The impeller (22) comprises a body (221) and multiple blades (222) which have a front edge (222a) and a rear edge (222b) on each blade. The front edge (222a) and the rear edge (222b) respectively define a inlet side and a outlet side. The multiple blades (222) are mounted at equal distance around the peripheral edge of the body (221), and flow channels (223) are formed between blades (222). Furthermore, the rear edges (222b) of the blades (222) are provided with inner and outer breaches (224, 225) having the same sectional shape with the inner and the outer ring member (21, 21′).

In assembling, the inner and the outer ring member (21, 21′) are inserted into the inner and outer breaches (224, 225) of the blades (222) of the impeller (22) and are fixed in position by the engagement of the protruding edge (215) onto the bottom edge of the body (221). The abovementioned rib (213) and the boosting blade (213′) are just located respectively in the flow channel (223) formed between two blades (222) of the impeller (22) after the assembling of the inner and the outer ring member (21, 21′) as well as the impeller (22).

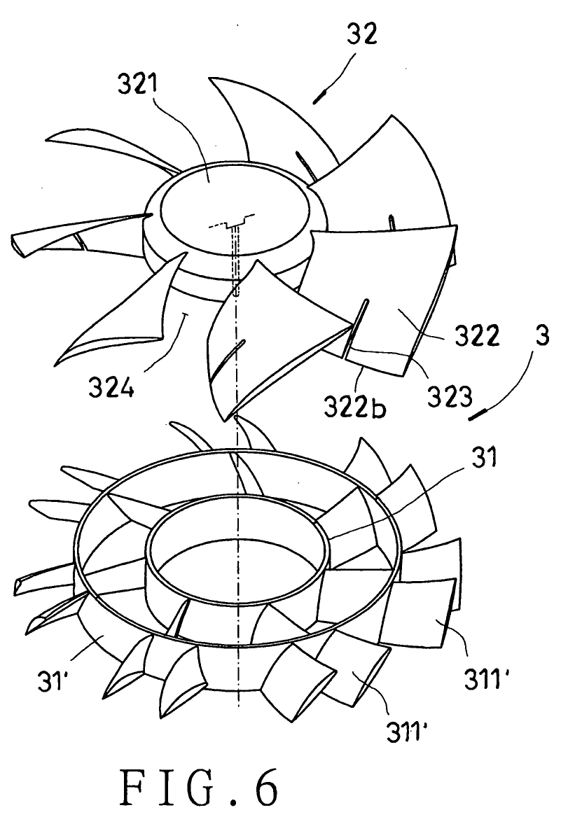

Referring to FIG. 6, 7, the fourth preferred embodiment of the impeller assembly of the present invention is shown. The impeller assembly (3) of the fourth preferred embodiment is substantially similar to the structure of the impeller assembly (2) of the third preferred embodiment, i.e., comprising at least two ring members (31, 31′) and an impeller (32). In this embodiment, the difference between the impeller assembly (3) and the impeller assembly (3) will be described as follow.

The upper end edge of the inner ring member (31) of the impeller assembly (3) abuts against the lower end edge of the body (321) of the impeller (32). The outer ring member (31′) is similarly inserted into the breaches (323) on the bottom edge (322b) of the blade (322) on the outer peripheral wall of the body (321) of the impeller (32). The cross section of the inner and the outer ring member (31, 31′) is equal in upper side and lower side width so as to keep merely the axial flow-out of air and to avoid the generation of radial flow field. Furthermore, at least one boosting blade (311′) is provided in the outer ring member (31′) with respect to the flow channel (324) between blades (322) of the impeller (32).

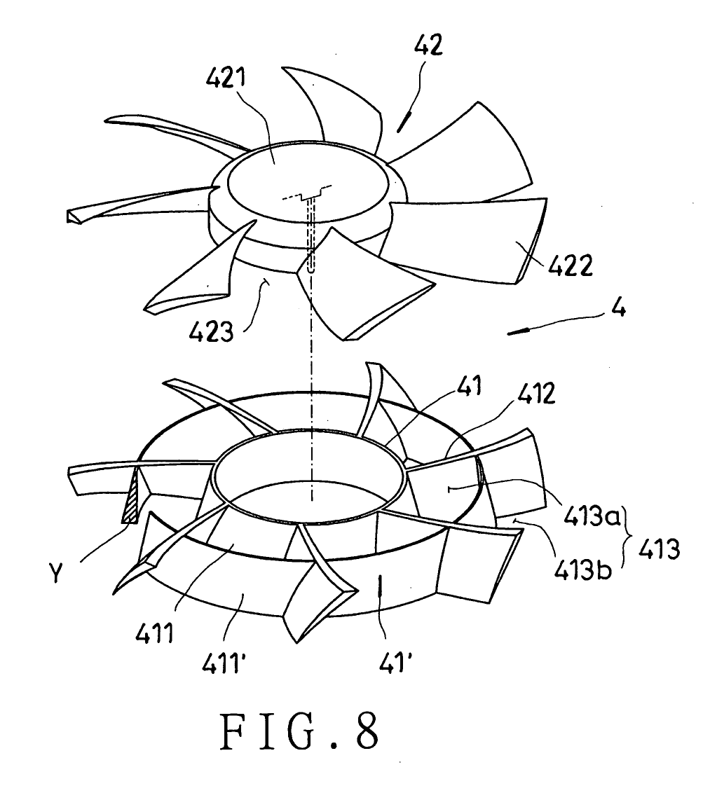

Referring to FIG. 8, the fifth preferred embodiment of the impeller assembly of the present invention is shown. The impeller assembly (4) is formed by at least two ring members (41, 41′) and an impeller (42).

These ring members (41, 41′) are respectively defined as an inner ring member (41) which is in proximity to the body (421) of the impeller (42), and an outer ring member (41′) which is far away from the body (421) of the impeller (42). The cross section of the inner and outer ring member (41, 41′) is either narrow on upper side and wide on lower side, or equal on both the upper side and the lower side (in FIG. 8, only the sectional shape with narrow on upper side and wide on lower side is illustrated herein at Y). Besides, the outer peripheral edges (411, 411′) of the inner and outer ring member (41, 41′) forms a slope shape or a streamline shape. Multiple secondary blades (412) corresponding to the primary blades (422) of the impeller (42) are arranged at equal distance along the outer peripheral edge (411) of the inner ring member (41). The secondary blades (412) are linked with the outer ring member (41′) and extend to the outside of the inner ring member (41′). The secondary flow channels (413) are formed between the secondary blades (412), and the secondary flow channels (413) are divided into two parts (413a, 413b) by the provision of the outer ring member (41′).

The impeller (42) comprises a body (421) and multiple primary blades (422) which are arranged around the peripheral edge of the body (421). Multiple primary flow channels (423) are formed between the primary blades (422).

When the inner and the outer ring member (41, 41′) as well as the impeller (42) are assembled with each other, the upper end edge of the inner ring member (41) abuts oppositely with the lower end edge of the body (421), whereas the lower end edge of the primary blades (422) of the impeller (42) abut correspondingly with the upper end edge of the secondary blades (412) of the inner ring member (41). In this manner, the cross section of the flow channels (413) located at the parts (413a, 413b) of the outer ring member (41, 41′) are tapered toward the outlet side such that the air introduced can be compressed by smaller cross section to raise the air pressure.

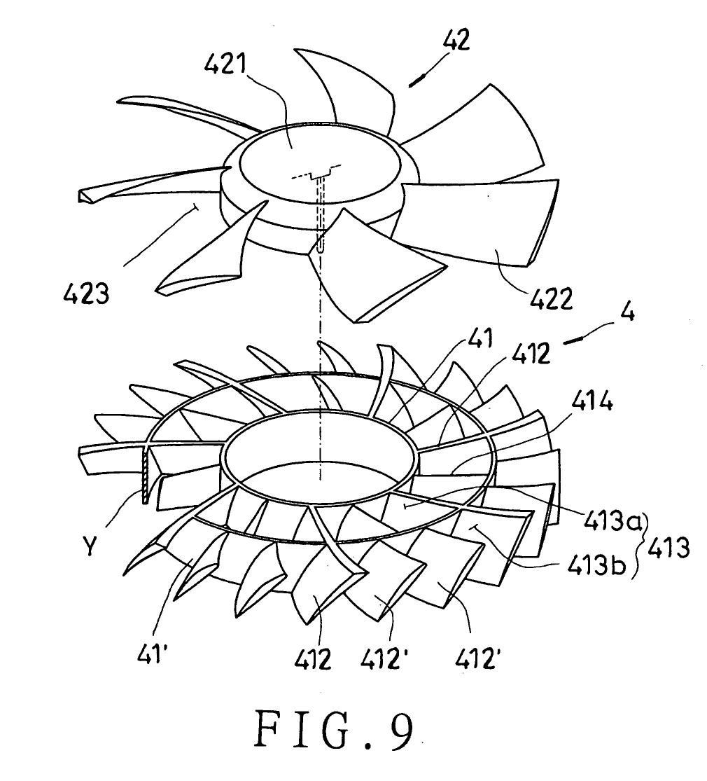

Referring to FIG. 9, 10, the sixth preferred embodiment of the impeller assembly of the present invention is shown. The difference of this embodiment with the impeller assembly (4) of the fifth preferred embodiment will be described as follow.

The cross section of the inner and outer ring member (41, 41′) is either equal on both the upper side and the lower side, or narrow on upper side and wide on lower side (in FIG. 9, only the case having sectional shape being equal on both the upper side and the lower side is illustrated herein at Y) so as to keep merely the axial flow-out of air and to avoid the generation of radial flow field. Furthermore, at least one inner boosting blade (414) and one outer boosting blade (412′) are provided respectively between the inner and outer parts (413a, 413b) of the flow channels (413). The purpose of providing the inner and the outer boosting blade (414, 412′) is to raise the air pressure, at the mean time to suppress the flow of the blown-out air back to the primary flow channels (423).

Based on the detailed description of the features of the above structure, this invention apparently has the following advantages.

1. The provision of ring member enables the flow field unhindered and noise reduction, and provides the space required for providing boosting blades.

2. The provision of ring member tapering from lower side to upper side enables gradual shrinkage of cross section of the flow channels between the parts of ring member toward the air outlet such that the air introduced can be compressed by smaller cross section so as to raise the air pressure. At the mean time, diagonal centrifugal acceleration effect can be formed between the outer peripheral edge and the blades of the impeller such that acceleration time of the blades with respect to air can be increased to enhance the air momentum.

3. The provision of ring member having equal width on upper and lower sides can prevent the generation of radial flow field so as to keep merely axial flow-out of air.

4. The connection of two ring bodies by ribs needs only one-shot injection molding for manufacturing. This simplifies the conventional method of two-shot injection molding and the subsequent assembling process. Furthermore, the ribs have the function of supporting the outer ring member such that the difficulty in positioning the outer ring member can be eliminated.

5. When ribs are designed according to the structure of the boosting blades, the air resistance can be reduced and the pressure of the blown-out air can be increased.

6. The boosting blades provided in the parts of the ring bodies can raise the air pressure and suppress the flow of blown-out air back to the flow channels.

Summing up above, the impeller assembly of the present invention depicted by preferred embodiment can reach expected effectiveness, and the specific configurations disclosed herein is not seen in the prior art of the same category.

While the present invention has been described with preferred embodiments in conjunction with the accompanying drawings, it is noted that the preferred embodiments and the drawings are purely for the convenience of description only, not intended to be restrictive on the scope of the present invention. Any modifications and variations or the equivalents brought out without departing from the spirit of the present invention is considered to be still within the scope of the present invention.

What is claimed is:

1. An impeller assembly, comprising:
at least one ring member, having an inner peripheral edge and an outer peripheral edge oppositely facing to each other; and
an impeller, including a body and multiple blades,
wherein each blade has a front edge and a rear edge, the front edge and the rear edge respectively define an inlet side and an outlet side; the multiple blades are mounted around the outer peripheral edge of the body; multiple flow channels are formed between the blades; the rear edges of the blades are provided with breaches having the same cross sectional shape with the ring member; and the ring member is provided into the breaches of the rear edges of the blades.

2. An impeller assembly in accordance with claim 1, wherein said impeller assembly comprises at least two ring members provided respectively at inner side and outer side; at least one rib is connected between said two ring members, and said rib is located within said flow channel; the bottom edges of the multiple blades of the impeller are provided with breaches, the quantity of which corresponds to the quantity of said ring member.

3. An impeller assembly in accordance with claim 2, wherein the cross section of said rib is an air-foil shape.

4. An impeller assembly in accordance with claim 3, wherein at least one boosting blade is provided at the outer peripheral edge of said outer ring member, and said boosting blade is located within said flow channel.

5. An impeller assembly in accordance with claim 1, wherein the cross section of at least one ring member is narrow on upper side and wide on lower side such that the cross section of said flow channels between the parts of the outer peripheral edges of the inner and the outer ring bodies tapers in the direction of said outlet side.

6. An impeller assembly in accordance with claim 1, wherein the cross section of at least one ring member is equal on upper and lower sides such that the cross section of said flow channels between the parts of the outer peripheral edges of the inner and the outer ring bodies is equal in width in the direction of said outlet side.

7. An impeller assembly in accordance with claim 1, wherein the said ring member can be a single inner ring which has a cross section with an upper portion narrower than the lower portion, and the outer peripheral edge of said ring member is provided with at least one boosting blade which is located at each outlet side of the flow channels.

8. An impeller assembly in accordance with claim 1, wherein said impeller assembly comprises at least two ring members provided respectively at inner side and outer side; at least one rib is connected between said two ring members, and said rib is located within said flow channel; the upper end edge of said inner ring member oppositely abuts against the lower end edge of the body of the impeller; the breaches provided on the bottom edges of the blades of the impeller correspond to said outer ring member and is used for the install of said outer ring member.

9. An impeller assembly in accordance with claim 8, wherein said outer peripheral edge of the ring member located at the outside is provided with at least one boosting blade which is located within said flow channel.

10. An impeller assembly in accordance with claim 8, wherein the cross section of said rib is an air-foil shape.

11. An impeller assembly in accordance with claim 10, wherein the cross section of at least one ring member is narrow on upper side and wide on lower side such that the cross section of said flow channels between the parts of the outer peripheral edges of the inner and the outer ring bodies tapers in the direction of said outlet side.

12. An impeller assembly in accordance with claim 10, wherein the cross section of at least one ring member is equal on upper and lower sides such that the cross section of said flow channels between the parts of the outer peripheral edges of the inner and the outer ring members is equal in width in the direction of said outlet side.

13. An impeller assembly, comprising:
at least two ring members, multiple secondary blades corresponding to the primary blades of the impeller are arranged at equal distance along the outer peripheral edge of the inner ring member, said secondary blades are linked with the outer ring member and extend to the outside of the inner ring member; multiple secondary flow channels are formed between the secondary blades, and are divided into two parts by the provision of the outer ring member;
an impeller, including a body and multiple primary blades which are mounted around the peripheral edge of the body, multiple primary flow channels are formed between said primary blades; the upper end edge of the inner ring member abuts oppositely with the lower end edge of the body, whereas the lower end edge of the primary blades of the impeller abuts correspondingly with the upper end edge of the secondary blades of the inner ring member.

14. An impeller assembly in accordance with claim 13, wherein the cross section of at least one ring member is narrow on upper side and wide on lower side such that the cross section of said flow channels between the parts of the outer peripheral edges of the inner and the outer ring members tapers in the direction of said outlet side.

15. An impeller assembly in accordance with claim 13, wherein the cross section of at least one ring member is equal on upper and lower sides such that the cross section of said flow channels between the parts of the outer peripheral edges of the inner and the outer ring members is equal in width in the direction of said outlet side.

16. An impeller assembly in accordance with claim 13, wherein at least one boosting blade is provided between the secondary blades of said inner ring member.

17. An impeller assembly in accordance with claim 13, wherein at least one boosting blade is provided between the secondary blades of said outer ring member.
